(19) United States
(12) Patent Application Publication
(10) Pub. No.: US 2014/0133891 A1
(43) Pub. Date: May 15, 2014

(54) FIXING MEMBER, FIXING APPARATUS, AND METHOD OF PRODUCING FIXING MEMBER

(71) Applicant: Yuji Kitano, Tokyo (JP)

(72) Inventor: Yuji Kitano, Tokyo (JP)

(73) Assignee: CANON KABUSHIKI KAISHA, Tokyo (JP)

(21) Appl. No.: 14/130,456

(22) PCT Filed: Jun. 21, 2012
(86) PCT No.: PCT/JP2012/066467

§ 371 Date: Dec. 31, 2013

(30) Foreign Application Priority Data
Jul. 4, 2011 (JP) 2011-148373

(51) Int. Cl. G03G 15/20

(52) U.S. Cl. CPC G03G 15/206
USPC 399/333; 522/75; 524/99

(57) ABSTRACT

The present invention relates to a fixing member that can apply a sufficient pressure to toner particles even at convex portions of a paper surface while maintaining an advantage of a surface layer composed of a soft rubber layer, i.e., high conformity to concave portions of a paper surface and that prevents adhesion of contamination to the surface and hardly changes the fixing ability thereof. The fixing member has a surface layer that comes into contact with toner. The surface layer has a sea-island structure including a sea phase of fluororubber and an island phase of a silicone compound having a crosslinked structure; is constituted so that a tangential elastic modulus, being the slope of a stress-strain curve of the surface layer, increases with an increase in strain in a strain range of 0.25 to 0.8; and contains an ionic liquid.

### TECHNICAL FIELD

The present invention relates to a fixing member used for heat fixation of an electrophotographic image, a method of producing the member, and a fixing apparatus.

### BACKGROUND ART

An electrophotographic image-forming apparatus forms toner images on various recording materials. In particular, paper, which is most commonly used as a recording material, has irregularities on the surface due to paper fibers, and toner images are formed on the irregularities. Unfixed toner particles placed on such paper are crushed by being pressed with a fixing member, while being heated, and are thereby fixed on the paper surface. When the fixing member has a hard surface layer, toner present on convex portions of a paper surface is well crushed, but toner present in concave portions of the paper surface is not sufficiently pressed by the fixing member. This may cause a portion having the toner remaining in a particle form and thereby having low gloss. As a result, a fixed toner image formed on one piece of paper includes high gloss portions and low gloss portions. In contrast, in a fixing member having a soft surface layer, the surface layer well conforms to the concave portions on a paper surface, comes into sufficient contact with also the toner particles lying in the concave portions of the paper surface, and thereby can apply pressing force to the toner particles even in the concave portions. PTL 1 discloses a fixing member having a soft surface layer. The fixing member has a toner-releasing layer containing fluororubber having an ether bond in the molecule and a polysiloxane surfactant having a polyether structure.

### CITATION LIST

### Patent Literature

PTL 1 Japanese Patent Laid-Open No. 2007-058197

### SUMMARY OF INVENTION

### Technical Problem

Unfortunately, the study by the present inventors has given the following findings. That is, an increase in conformity to the concave portions of paper by softening the surface layer of a fixing member decreases the pressing force against toner particles present on the convex portions of the paper. This insufficient pressing force allows the toner particles to remain in the particle form and makes the gloss of the toner image insufficient at the convex portions of the paper surface in some cases. In addition, the surface of the fixing member is required to be prevented from adhesion of toner and other substances.

### Solution to Problem

Accordingly, one aspect of the present invention provides a fixing member that can not only apply sufficient pressing force to toner particles present on the convex portions of a paper surface but also maintain the advantage of a soft rubber surface layer, i.e., good conformity to concave portions of the paper surface, and can prevent the surface thereof from being contaminated and prevent the fixing ability from varying. Another aspect of the present invention provides a method of producing such a fixing member.

Further another aspect of the present invention provides a fixing apparatus that can stably form an electrographic image showing uniform gloss and having high quality.

According to one aspect of the present invention, there is provided a fixing member comprising a surface layer having a surface including a sea phase containing fluororubber and an island phase formed of a silicone compound having a crosslinked structure, wherein the surface layer is constituted so that a tangential elastic modulus, being the slope of a stress-strain curve of the surface layer, increases with an increase in strain in a strain range of 0.25 to 0.8; and the surface layer comprises an ionic liquid.

According to another aspect of the present invention, there is provided a fixing apparatus having the aforementioned fixing member.

According to further aspect of the present invention, there is provided a method of producing a fixing member comprising a surface layer having a surface including a sea phase containing fluororubber and an island phase formed of a silicone compound having a crosslinked structure, wherein the surface layer is constituted so that a tangential elastic modulus, being the slope of a stress-strain curve of the surface layer, increases with an increase in strain in a strain range of 0.25 to 0.8; and the surface layer contains an ionic liquid, the method including a step of forming a surface layer by hardening a coating film of a surface layer-forming solution containing a fluoropolymer, a silicone surfactant, and the ionic liquid by irradiating the coating film with an electron beam or heat.

### Advantageous Effects of Invention

According to an aspect of the present invention, provided is a fixing member that can contribute to stable formation of high gloss electrographic images.

Furthermore, according to another aspect of the present invention, provided is a fixing apparatus that can contribute to prevention of occurrence of portions where toner remains in a particle form at concave portions of paper and to stable formation of a high gloss fixed image.

### BRIEF DESCRIPTION OF DRAWINGS

FIG. 1 is a stress-strain curve of surface layer rubber according to the present invention.

FIG. 2 is a tangential elastic modulus-strain curve of surface layer rubber according to the present invention.

FIG. 3 is a cross-sectional view of surface layer rubber being in contact with irregularities by pressure according to the present invention.

FIG. 4 is a cross-sectional view of a fixing member according to the present invention.

FIG. 5 is a structural view of one embodiment of a fixing apparatus provided with a fixing member according to the present invention.

FIG. 6 is a graph showing stress-strain curves of Examples and Comparative Examples.

FIG. 7 is a graph showing tangential elastic modulus-strain curves of Examples and Comparative Examples.

FIG. 8 is a graph showing relationships between the strain and the volume resistivity values of fixing members according to Example 3 and Comparative Examples 1, 3, and 4.

FIG. 9A is a graph showing relationships between the strain and the volume resistivity values of fixing members according to Examples 1, 2, and 3 and Comparative Example 2.

FIG. 9B is a graph showing relationships between the strain and the volume resistivity values of fixing members according to Examples 4, 5, and 6 and Comparative Example 2.

FIGS. 10A to 10C are explanatory drawings of a crosslinking reaction of a silicone compound by irradiation with an electron beam.

### DESCRIPTION OF EMBODIMENTS

The fixing member according to the present invention includes a surface layer having a surface including a sea phase containing fluororubber and an island phase formed of a silicone compound having a crosslinked structure. The surface layer is constituted so that the tangential elastic modulus, being the slope of a stress-strain curve of the surface layer, increases with an increase in strain in a strain range of 0.25 to 0.8. In addition, the surface layer contains an ionic liquid.

Throughout the specification, the value “0.25”, the lower limit of the numerical range of strain in the stress-strain curve, is a value of strain inevitably generated in the surface layer when toner is fixed using a fixing member having a surface layer containing rubber. It is unlikely that the strain exceed 0.8 even under high pressure of the fixing conditions normally used. Accordingly, 0.8 is set as the upper limit of the strain. The use of a fixing member having a surface layer of which tangential elastic modulus increases with an increase in strain in the strain range of 0.25 to 0.8 allows toner fixed images to have high gloss while maintaining an advantage of a rubber surface layer, i.e., allowing the surface layer to maintain good conformity to the concave portions of paper. The irregularities on a paper surface are made by array of paper fibers, and the height of the irregularities varies within a certain range. That is, there are various heights of the irregularities on the surface of one piece of paper, and the strain of the surface layer rubber of the fixing member is therefore not uniform when the fixing member is brought into contact with a paper surface by pressure, causing various levels of strain locally in the contact surface by pressure.

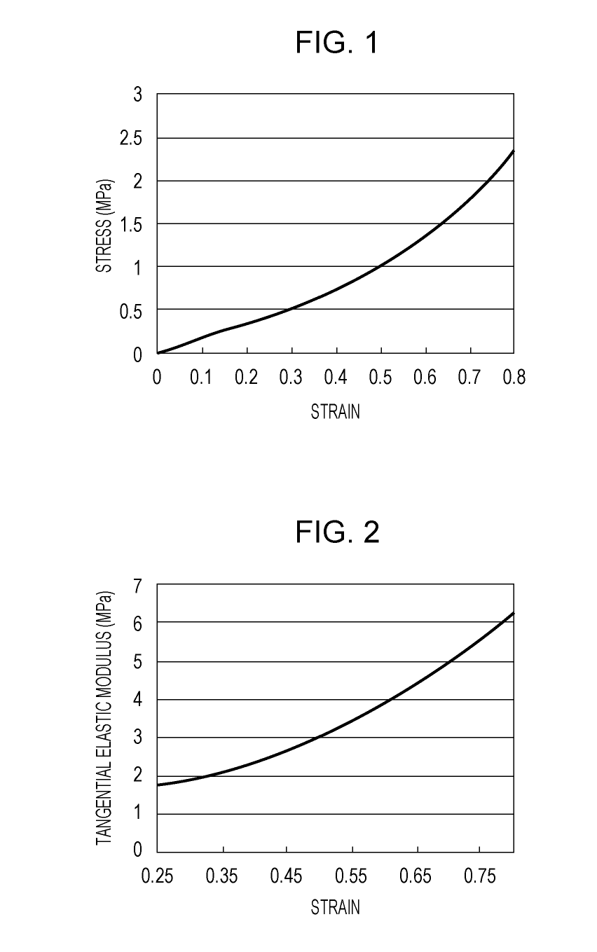

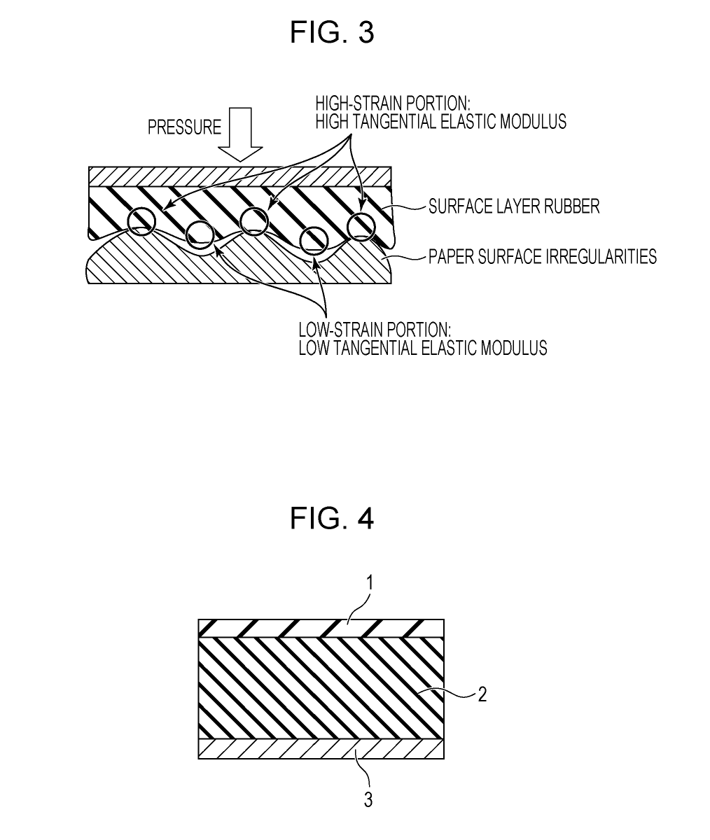

As shown in FIGS. 1 and 2, in a surface layer according to the present invention, in a strain range of 0.25 to 0.8 of the stress-strain curve of the surface layer, the tangential elastic modulus, being the slope of the curve, increases with the strain. The tangential elastic modulus represents the hardness of rubber at a certain level of strain. That is, the surface layer according to the present invention has characteristics that the hardness of rubber changes depending on the level of strain, so that the rubber is relatively soft when the strain is small and that the rubber is relatively hard when the strain is large. Accordingly, as schematically shown in FIG. 3, in the surface layer according to the present invention, the portions in contact with the concave portions of a paper surface have a relatively low strain. On the other hand, the portions in contact with the convex portions of paper have a relatively high strain (see FIG. 3).

That is, in the surface layer, the portion in contact with a concave portion is relatively soft. The surface layer, therefore, can conform to unfixed toner particles in the concave portion and can sufficiently apply a pressing force to the toner particles. In contrast, the portion in contact with a convex portion is relatively hard, and unfixed toner particles present on the convex portion are therefore well crushed. As a result, an electrophotographic image having uniform gloss can be formed.

As described above, since there are variations in the irregularities on a paper surface, the levels of strain of the surface layer are not only two, i.e., high and low, and various levels of strain are partially generated. A surface layer of which the tangential elastic modulus, being the slope of the stress-strain curve, uniformly increases with the strain can well achieve both conformity to concave portions and crush of toner.

According to the study by the present inventors, it has been found that the tangential elastic modulus of ordinary rubber decreases with an increase in strain, on the contrary to the surface layer according to the present invention. That is, as the strain decreases, rubber becomes relatively hard, and as the strain increases, rubber becomes relatively soft. Accordingly, a fixing member having a surface layer containing ordinary rubber is considered to be disadvantageous to obtain a high gloss image by reducing toner particles remaining in a particle form.

In rubber showing a linear relationship of strain-stress, the hardness does not change even if the strain varies, and it is therefore considered to be difficult to achieve both prevention of toner particles from remaining in a particle form at concave portions of paper and an increase in gloss.

In the fixing conditions of ordinary electrophotographic images, it is unlikely that the strain of a surface layer exceed 0.8. The fixing conditions herein are the pressure conditions in a fixing nip portion. Though the pressure varies depending on the setting of a fixing unit, it is unlikely that the strain of a surface layer exceed 0.8 even in a high pressure setting within the practical range. The strain of a surface layer throughout the specification refers to a ratio of stretched length to initial length in the uniaxial tension in a state where rubber is unconstrained in the direction perpendicular to the tensile direction. Rubber has a Poisson's ratio of approximately 0.5 and hardly changes the volume thereof. In an actual fixing nip portion, rubber is probably constrained also in the longitudinal direction of the nip, i.e., the direction perpendicular to the feeding direction of paper when the feeding direction is defined as the tensile direction. Accordingly, for example, in a case of coated paper having a smooth surface, a condition that a surface layer of the present invention has a strain of 0.8 probably corresponds to a condition where the surface layer is compressed by about 44% in the thickness direction at the fixing nip portion. A fixing condition where the strain of a surface layer exceeds 0.8 means further compression of the surface layer in the thickness direction and tends to cause a problem in durability of the surface layer, and is, therefore, practically unlikely. In addition, for example, in a case of coated paper having a smooth surface, a condition where the strain of a surface layer of the present invention is 0.25 corresponds to a condition where the surface layer is compressed by about 20% in the thickness direction in the fixing nip portion.

In a strain range of 0.8 or less, for example, in generally used fluororubber, the tangential elastic modulus decreases with an increase in strain. The generally used fluororubber refers to polyamine-crosslinked, polyol-crosslinked, or peroxide-crosslinked rubber. These types of fluororubber are usually obtained by subjecting components necessary for crosslinking to a crosslinking reaction by heating. The energy enhancing the crosslinking reaction is heat. The crosslinking is usually carried out at 200° C. or less at the highest with an energy of less than 100 kcal/mol at the highest. However, even in the thermally-crosslinked fluororubber, in the range of very high strain exceeding 0.8, the tangential elastic modulus increases with an increase in strain.

Unlike these commonly-known thermal crosslinking methods, the surface layer of which tangential elastic modulus increases with the strain in a strain range of 0.8 or less can be formed by electron beam irradiation. That is, in a substance irradiated with electrons, the electrons interact with extranuclear electrons in the substance to generate secondary electrons. The secondary electrons are estimated to have an average energy of about 2600 kcal/mol, which is remarkably higher than the energy for thermal crosslinking. These secondary electrons accelerate the crosslinking reaction. Consequently, the crosslinking reaction furthermore progresses compared to the commonly-known thermal crosslinking. As a result, the crosslink density increases. This probably causes an increase in strain accompanied with an increase in the tangential elastic modulus even in a strain range of 0.8 or less. Irradiation with an electron beam may be performed against a thermally crosslinked surface layer or against an uncrosslinked surface layer.

The atmosphere for electron beam irradiation can be an inert gas atmosphere and further can be a nitrogen gas atmosphere with an oxygen concentration of 20 ppm or less. The reduction of the oxygen concentration can prevent oxidation of the rubber of the surface layer and can prevent an increase in surface energy of the rubber, resulting in prevention of deterioration of toner-releasing property or adhesion of a filler contained in paper to the rubber surface. The accelerating voltage of an electron beam may be appropriately set depending on the thickness of the surface layer. A variation in the accelerating voltage changes the depth that the electrons can reach from the surface of the surface layer toward the inside. Accordingly, the accelerating voltage is required to be set depending on the thickness of the surface layer. For example, in a case of a surface layer having a thickness of 30 μm, the accelerating voltage can be 80 kV or more. In addition, the degree of crosslinking of a rubber surface layer can be changed by varying the conditions such as the irradiation current value and irradiation time.

The surface layer of the present invention has a sea-island structure including a sea phase containing fluororubber and an island phase formed of a silicone compound having a crosslinked structure.

Specific examples of fluororubber polymer (fluoropolymer) constituting the sea phase include bipolymers of vinylidene fluoride and hexafluoropropylene; terpolymers of vinylidene fluoride, hexafluoropropylene, and tetrafluoroethylene; and terpolymers of vinylidene fluoride having an ether group, tetrafluoroethylene, and perfluoro(alkyl vinyl ether).

The terpolymer of vinylidene fluoride having iodine or bromine in the molecule as a reaction site, tetrafluoroethylene, and perfluoro(methyl vinyl ether) can be synthesized by a known method. These terpolymers are commercially available, and specific examples thereof include “Daiel LT-302” (manufactured by Daikin Industries, Ltd.); and “Viton GLT”, “Viton GLT-305”, “Viton GLT-505”, “Viton GFLT”, “Viton GFLT-300”, “Viton GFLT-301”, “Viton GFLT-501”, and “Viton GFLT-600” (manufactured by DuPont Dow Elastomers Japan K.K.).

The silicone compound constituting the island phase can be a polysiloxane surfactant (silicone surfactant) having a structure including polyoxyalkylene, which is a hydrophilic group, and dimethylpolysiloxane, which is a hydrophobic group, from the viewpoint of the toner-releasing property. The polysiloxane surfactants can be classified based on the structures thereof into three types. Dimethylpolysiloxane, as an example, is classified as follows:

(1) a side chain modified type having a structure in which polyoxyalkylene is linked to a side chain of a dimethylpolysiloxane skeleton;

(2) an end modified type having a structure in which polyoxyalkylene is linked to an end of a dimethylpolysiloxane skeleton; and

(3) a copolymerization type having a structure in which dimethylpolysiloxane and polyoxyalkylene are alternately and repeatedly linked to each other.

Among them, the copolymerization type (3) has the most excellent dispersibility in fluororubber and is therefore particularly excellent. The amount of the polysiloxane surfactant can be 40 parts by mass or more and 60 parts by mass or less based on 100 parts by mass of the fluororubber polymer when the fluorine content of the fluororubber polymer is low, while when the fluorine content of the fluororubber polymer is high, the amount of the polysiloxane surfactant can be 20 parts by mass or more and 40 parts by mass or less.

The fluororubber can be a type having iodine or bromine at a molecular chain terminal or a side chain. Crosslinking in such fluororubber is probably due to abstraction of iodine or bromine atoms by irradiation with an electron beam and a radical reaction of a crosslinking auxiliary agent to an allyl group. Examples of the crosslinking auxiliary agent include triallyl cyanurate and triallyl isocyanurate. The triallyl isocyanurate can be particularly used.

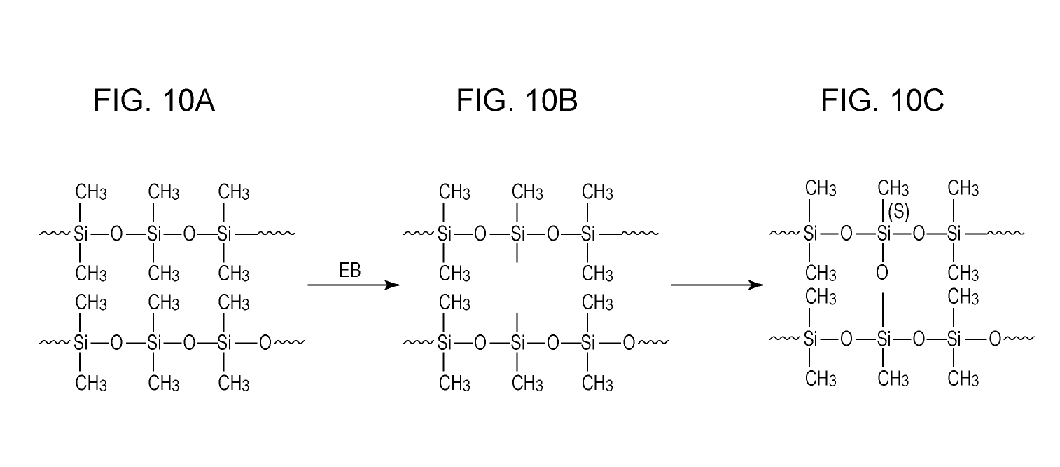

FIGS. 10A to 10C schematically illustrate crosslinking that probably occurs by irradiating the island phase containing a polysiloxane surfactant with an electron beam. That is, the irradiation with an electron beam cleaves a part of Si—CH₃ bonds of the dimethylsilicone moiety in the polysiloxane surfactant (FIG. 10B). The cleaved sites are relinked to each other through an oxygen atom to bridge the chains of dimethyl silicone (FIG. 10C). Such formation of the linkage can be confirmed by, for example, ¹³C solid NMR through the peak of a carbon atom derived from the newly formed structure represented by the following Chemical Formula (3) present in the structure shown in FIG. 10C, wherein the peak appears the higher magnetic field side than the peak indicating the presence of a usual (CH₃)₂SiO-derived carbon atom.

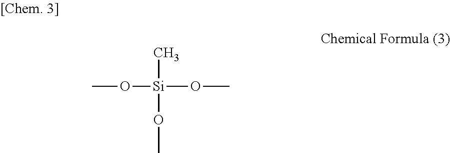

The polysiloxane surfactant according to the present invention can have a carbon-carbon unsaturated bond at each of both molecular chain terminals. Crosslinking by irradiation of such a polysiloxane surfactant with an electron beam is probably caused by, in addition to resinification of the dimethylsiloxane moiety, the radical reaction of an unsaturated bond and the radical reaction of an allyl group of the crosslinking auxiliary agent. In addition, crosslinking by a radical reaction probably occurs at the interface between the fluororubber polymer of the sea phase and the polysiloxane surfactant of the island phase.

As one method for reducing adhesion of toner and other substances to the surface of a fixing member, it is known to prevent charging of the surface of the fixing member by decreasing the volume resistivity of the surface layer of the fixing member to thereby prevent electrostatic adhesion of toner, the filler contained paper, and other substances.

Accordingly, the present inventors have tried to reduce the volume resistivity of a surface layer by adding an ion conducting agent to the surface layer, where the surface layer has a sea-island structure including a sea phase containing fluororubber and an island phase formed of a silicone compound having a crosslinked structure and has characteristics that in a strain range of 0.25 to 0.8 in a stress-strain curve, the tangential elastic modulus, being the slope of the curve, increases with the strain. As a result, the inventors have found that the effect of reducing the volume resistivity of the surface layer is significantly low with respect to the amount of the ion conducting agent in some cases. This will now be described in detail.

That is, the present inventors added, for example, lithium nonafluoro-1-butanesulfonate or potassium trifluoromethanesulfonate as an ion conducting agent to the surface layer having the above-described characteristics. As a result, the volume resistivity of the surface layer was about 4.0 to 6.0×10¹¹ Ω·cm, and an increase in the volume resistivity value proportional to the level of strain applied to the surface layer was observed.

In contrast, in the case of adding the same amount of the ion conducting agent to the surface layer where crosslinking was formed by heating only, the volume resistivity was about 4.0 to 6.0×10⁹ Ω·cm, which was about 1% of the volume resistivity value of the surface layer having the above-described characteristics. No notable increase in the volume resistivity due to a change in the strain applied to the surface layer was observed.

This suggests that in the surface layer having the characteristics according to the present invention, the fluororubber constituting the sea phase is densely crosslinked to inhibit ions from moving, and the movement of ions is probably further inhibited with an increase in the strain applied to the surface layer.

Accordingly, the present inventors have investigated application of sufficient conductivity to the surface layer according to the present invention. As a result, the inventors have found that the electrical resistivity of the surface layer can be sufficiently reduced by adding an ionic liquid to the surface layer according to the present invention.

### Ionic Liquid

The term “ionic liquid” generally refers to a salt that can be present in a liquid state at a temperature range of 25 to 100° C. Inorganic salts represented by NaCl become liquids at high temperature of about 800° C. or more. This is probably because that the ion sizes of these salts are small and interactions between ions are very strong. On the other hand, the ionic liquids have relatively large ionic sizes compared to general inorganic salts and thereby probably have weak interactions between ions and become liquids at relatively low temperature.

The ionic liquid that can be used is at least one selected from the group consisting of imidazolium salts, pyrrolidinium salts, pyridinium salts, ammonium salts, phosphonium salts, and sulfonium salts.

In the present invention, ionic liquids including a cation selected from imidazolium ions, pyrrolidinium ions, and pyridinium ions and an anion having a fluoroalkyl group can be particularly used, because of that the cations containing nitrogen-containing rings mentioned above probably have high heat resistance and that the anions having fluoroalkyl groups probably have excellent dispersibility in the fluororubber constituting the sea phase of the surface layer. Table 1 shows specific examples of the ionic liquids.

TABLE 1

| Ionic liquid | | | |
|---|---|---|---|
| No. | Anion | Cation | Molecular weight |
| 1 | CF₃SO₃⁻ | 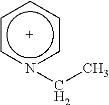 | 257 |
| 2 | CF₃(CF₂)₃SO₃⁻ | Same as above | 407 |
| 3 | (CF₃(CF₂)₃SO₂)₂N⁻ | Same as above | 688 |
| 4 | CF₃SO₃⁻ | 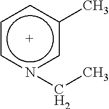 | 271 |
| 5 | CF₃(CF₂)₃SO₃⁻ | Same as above | 421 |
| 6 | (CF₃(CF₂)₃SO₂)₂N⁻ | Same as above | 702 |

In the case where the surface layer according to the present invention contains an ionic liquid represented by No. 2, 3, 5, or 6, the change in volume resistivity of the surface layer due to a change in level of the strain applied to the surface layer is particularly small. Accordingly, these ionic liquids can be used as the ion conducting agents for electric conduction of the surface layer according to the present invention. Specifically, Table 2 shows rates of change in volume resistivity value of the surface layers containing the same amount of the ionic liquid No. 1, 2, or 3, when the level of strain of the surface layer according to the present invention is increased to 0.4 from 0 as the reference of the volume resistivity value.

TABLE 2

| | Rate of change in volume |
|---|---|
| Ionic liquid No. | resistivity value (%) |
| 1 | 130 |
| 2 | 80 |
| 3 | 60 |

Similar results were obtained also in ionic liquids 4 to 6. Accordingly, the ionic liquids No. 2, 3, 5, and 6 showing small rates in change of volume resistivity against an increase in the level of strain can be particularly used for electric conduction of the surface layer according to the present invention.

Examples of the structure of the fixing member according to the present invention include the following structures:

a structure with a surface layer formed on a metal or resin substrate;

a structure with a thermal conductive silicone rubber layer formed on a substrate and a surface layer formed on the outer circumference surface of the thermal conductive silicone rubber layer; and

a structure with a thermal conductive silicone rubber layer formed on a substrate, an intermediate layer formed on the outer circumference surface of the thermal conductive silicone rubber layer, and a surface layer formed on the outer circumference surface. However, the fixing member of the present invention is not limited to these structures and may be a structure of five layers or more.

In particular, in a case of a four layer structure, an intermediate layer can be made of a resin harder than the base layer and the surface layer. Though the base layer and the surface layer are made of rubber, the intermediate layer can be made of a heat-resistant resin. Such a structure prevents excessive conformity to paper fibers while maintaining the advantages of a rubber surface layer, and thereby a higher gloss image can be formed.

The fixing member according to the present invention can be produced, for example, as follows.

A fluoropolymer having an ether group, a polysiloxane surfactant having an ether structure, triallyl isocyanurate as a crosslinking auxiliary agent, and an ionic liquid are dissolved in at least a ketone solvent, and the mixture is well stirred. The outer surface of a roller or belt is coated with this solution, dried, and then subjected to primary crosslinking by electron beam irradiation and secondary crosslinking in a normal heating oven or secondary crosslinking by heating in an inert gas.

The coating can be performed by a known method such as spray coating, slit coating, blade coating, roll coating, or dip coating. The thickness of the surface layer can be 10 μm or more and 500 μm or less for obtaining sufficiently high scratch resistance and abrasion resistance and also obtaining excellent thermal conductivity.

In a case of forming a thermal conductive silicone rubber layer, the thermal conductive silicone rubber layer may be produced by a known method, for example, a method of injecting a silicone rubber material into a mold die and curing the material with heat, or a method of forming a silicone polymer layer by coating and curing the layer in a heating oven. The thickness of the silicone rubber layer can be 50 μm or more for securing conformity to recording materials such as paper and can be 5 mm or less from the viewpoint of thermal conductivity.

FIG. 4 shows a cross section of a layer structure of a fixing member that can be produced as described above. In FIG. 4, the fixing member is composed of a surface layer 1 including a sea phase of fluororubber and an island phase of a silicone compound having a crosslinked structure; a thermal conductive layer 2 formed of silicone rubber; and a substrate 3. The provision of the surface layer 1 according to the present invention prevents occurrence of portions where toner remains in a particle form. Thus, a fixing member that can contribute to stable formation of images having high gloss can be provided.

The fixing member of the present invention may be in any configuration of a fixing belt, a fixing roller, a pressure belt, or a pressure roller.

### Fixing Apparatus

A fixing apparatus according to the present invention will now be described. The fixing apparatus according to the present invention is used in an electrophotographic image-forming apparatus, and the fixing member of the present invention described above is disposed as a fixing belt or a fixing roller and/or a pressure belt or a pressure roller. The electrophotographic image-forming apparatus include, for example, a photoreceptor, a latent image forming unit, a unit for developing the formed latent image with toner, a unit for transferring the developed toner image to a recording material, and a unit for fixing the toner image on the recording material.

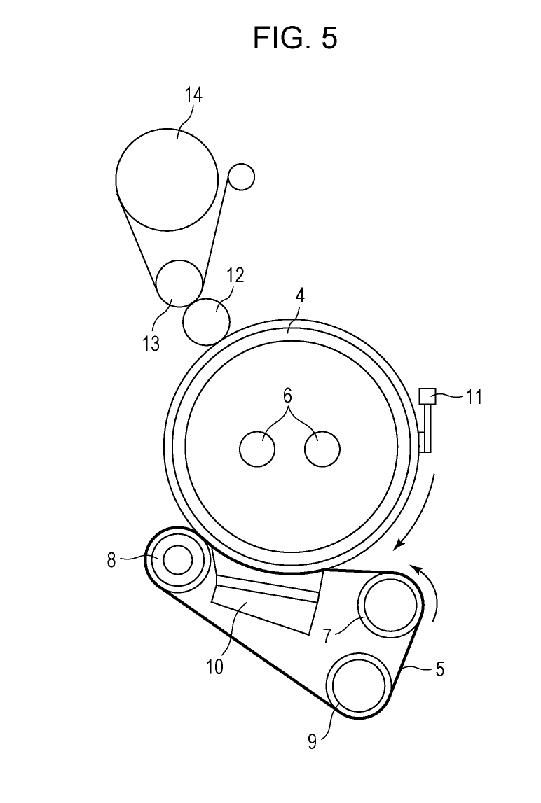

FIG. 5 is a cross-sectional view illustrating an embodiment of the fixing apparatus according to the present invention. A fixing roller 4 and a pressure belt 5 are disposed in the fixing apparatus. The fixing member of the present invention is used at least in the fixing roller 4. The fixing roller 4 is heated with a halogen heater 6 disposed inside the fixing roller 4. The pressure belt 5 lays across an entrance roller 7, a separation roller 8, and a steering roller 9 in a tensioned state. The separation roller 8 brings the pressure belt 5 into contact with the fixing roller 4 by pressing. The steering roller 9 is movable and corrects the bias of the pressure belt 5. A pressure pad 10 is disposed between the entrance roller 7 and the separation roller 8 and brings the pressure belt 5 into contact with the fixing roller 4 by pressing.

The fixing roller 4 is rotated in the arrow direction at a predetermined peripheral velocity by a driving source (not shown), and thereby the pressure belt 5 is also rotated in the arrow direction. The fixing temperature is maintained at a preset temperature by controlling the output of the halogen heater 6 on the basis of the surface temperature of the fixing roller 4 measured by a thermistor 11. The surface temperature (fixing temperature) of the fixing roller 4 is not particularly limited and is usually about 130 to 220° C.

A recording material such as paper having a toner image formed thereon is supported and fed by the fixing roller 4 and the pressure belt 5, and the toner image is fixed on the paper by heat from the halogen heater 6 and the pressure of the fixing roller 4 and the pressure belt 5. Contamination, such as toner and the filler of paper, adhering to the surface of the fixing roller 4 is transferred to the surface of a metal collecting roller 12 and is scraped by a cleaning web 14 that is pressed to the collecting roller 12 by a web roller 13. This fixing unit is a high pressure fixing unit. Here, the fixing apparatus employing a fixing roller and a pressure belt has been described as an example, but the fixing apparatus according to the present invention may include the fixing member of the present invention as a fixing belt or a fixing roller and/or a pressure belt or a pressure roller.

### EXAMPLES

The present invention will now be described in detail by examples.

Methods for evaluation and measurement of fixing members and surface layers according to Examples and Comparative Examples will be described.

### Determination of Stress-Strain Curve

The relationship between stress and strain of a surface layer was determined as follows. The surface layer sample according to each Example or Comparative Example was measured for the relationship between stress and strain. Table 3 shows the sample sizes and measurement conditions. The measurement was performed using a dynamic viscoelasticity measuring apparatus (trade name: Rheogel-E4000, manufactured by UBM Co., Ltd.).

TABLE 3

| | |
|---|---|
| Size of sample | Width: 5 mm, Length: 20 mm, Thickness: 50 μm |
| Sample holding | Hold both ends in the longitudinal direction of a |
| method | sample with a distance 10 mm between chucks |
| Atmospheric | 170° C. |
| temperature | |
| Tensile Speed | 0.055 mm/sec setting |

Stress-strain curves were drawn based on the measurement results. The stress in the present invention is a nominal stress obtained by dividing a load by the area of initial cross section of a sample. The strain is a nominal strain obtained by dividing a stretch by the initial length of a sample. The stress-strain curve according to the present invention is therefore a nominal stress-nominal strain curve. A strain value of “0.8” means a state where a sample having an initial length of 10 mm is elongated to 18 mm, i.e., 1.8-fold the initial length. The thickness of a sample in an elongated state was calculated provided that the volume of rubber does not change.

Furthermore, a tangential elastic modulus-strain curve was obtained by polynomial approximation (sixth order) of the stress-strain curve obtained by the method described above and differentiating the resulting polynomial by a strain variable.

### Determination of Relationship Between Electrical Resistivity Value and Strain

The surface layer of each Example or Comparative Example was cut out into a sample size as shown in Table 2, and a relationship between the electrical resistivity value (volume resistivity [Ω·cm]) measured using a resistivity meter (trade name: Hiresta-UP (model MCP-HT450), manufactured by Mitsubishi Chemical Analytech Co., Ltd.) and the strain of the surface layer was determined. The measurement conditions are shown in Table 4.

TABLE 4

| | |
|---|---|
| Size of sample | Width: 50 mm, Length: 50 mm, Thickness: |
| | 50 μm |
| Probe | URS |
| Applied voltage | 10 V |
| At the measurement time | 10 sec after starting of voltage application |
| Application of stain | Fix 5-mm long rubber (total: 10 mm) on both |
| | ends of a sample with tape in an extended state |

The strain is a nominal strain obtained by dividing a stretch by the initial length of a sample. A strain value of “0.4” means a state where a sample having an initial length of 40 mm is elongated to 56 mm, i.e., 1.4-fold the initial length. The thickness of a sample in an elongated state was calculated provided that the volume of rubber does not change.

### Evaluation of Fixing Member

The fixing member of each Example or Comparative Example was equipped to a fixing apparatus shown in FIG. 5. This fixing apparatus was installed in a color copier (trade name: ImagePress C1+, manufactured by CANON KABUSHIKI KAISHA). In this color copier, paper of an A4 size is fed in the lateral direction thereof. The color copier includes a fixing unit having a structure shown in FIG. 5.

A solid image (toner laid-on level: 0.4 mg/cm²) of cyan toner was formed on the upper half in the lateral direction of plain paper of A4 size was formed with the color copier. The image was continuously printed on 1000 sheets of paper. The fixing conditions were as follows:

Peak pressure applied to the nip portion: 0.3 MPa,

Surface temperature of the fixing roller: 170° C., and

Process speed: 300 mm/sec.

Evaluation of conformity of fixing member to paper surface and evaluation of glossiness

The conformity of the fixing member to concave portions of paper was evaluated as follows: The solid image of fixed cyan toner on the first printed paper was observed under a confocal microscope (manufactured by Lasertec Corporation) at a magnification of 10 times to obtain a gray scale observation image. This observation image was binarized to a portion where the toner did not maintain the particle shape and a portion where the toner maintained the particle shape using image processing software (trade name: Image-Pro Plus, manufactured by Media Cybernetics, Inc.). The area rate (%) of the portions where the toner did not maintain the particle shape to the whole area of the field of observation was determined. A higher level of this rate means that a larger amount of toner on the paper was brought into contact with the fixing member.

The glossiness of the fixed cyan toner solid image on the first printed paper was measured with a handy glossmeter (trade name: PG-1M, manufactured by HORIBA, Ltd.) at a 60° gloss value. A higher value means that the toner on the paper was well fixed.

### Evaluation of Contamination Adhesion to Fixing Member Surface

After the printing on 1000 sheets of paper, the surface of the cleaning web of the fixing member in the fixing apparatus of the color copier was visually observed for the degree of contamination to evaluate difficulty in contamination of the fixing member. That is, if the surface of the fixing member is easily contaminated, the contamination is cleaned by the cleaning web. Accordingly, difficulty in contamination of the surface of fixing member can be determined by observing the degree of contamination of the surface of the cleaning web. The observation position of the cleaning web is a position used for cleaning the surface of the fixing member at the portion that did not come into contact with the cyan toner on the paper during the printing, in order to avoid influence of toner on the evaluation of contamination adhesion.

### Strain of Surface Layer

The strain value of a surface layer in a fixing process of each Example or Comparative Example was calculated as follows.

The surface of A4-size plain paper (trade name: PB PAPER GF-500, manufactured by CANON KABUSHIKI KAISHA) used for image formation in each Example or Comparative Example was observed under a confocal microscope (manufactured by Lasertec Corporation) at a magnification of 10 times. The maximum irregularity height of the paper, Rz, was determined by the resulting observation image to be 17 μm.

Regarding the surface roughness of paper, the short-period irregularities by paper fibers (cutoff values: 8 μm and 80 μm) and the long-period irregularities by paper fibers (cutoff values: 80 μm and 800 μm) were measured. The value of the average length (RSm) of the roughness curve elements was defined as the irregularity period, and the value of the average height (Rc) of the roughness curve elements was determined as the irregularity height.

As a result, paper surface irregularities were modeled with synthetic waves of short-period irregularities having an RSm of 25 μm and an Rc of 5 μm and long-period irregularities having an RSm of 200 μm and an Rc of 12 μm.

The strain of a surface layer when a fixing roller according to each Example or Comparative Example was pressed at a predetermined pressure was determined according to static structural analysis calculation by a finite element method using the paper surface irregularity model described above. Specifically, the paper surface irregularity model and a cross-section model of each fixing member were produced using 3D CAD/CAE software (trade name: NX, manufactured by Siemens PLM Software Inc.) and were divided into elements at 0.5 mm pitch. Subsequently, static structural analysis calculation was performed using analysis solver (trade name: ABAQUS, manufactured by SIMULIA Inc.). Regarding the physical properties of the surface layer, the stress-strain curve of each surface layer was approximated by a hyperelastic 3D OGDEN model (Poisson's ratio: 0.48). The physical properties of the paper were calculated using a linear elastic modulus of 150 MPa and a Poisson's ratio of 0.4.

### Example 1

An addition reaction type liquid silicone rubber was molded using a metal mold onto the outer circumference surface of an aluminum hollow cylindrical mandrel having an outer diameter of 77 mm, heated at 130° C. for one hour, demolded, and then subjected to secondary crosslinking at 200° C. for 4 hours to form a silicone rubber elastic body layer having a thickness of 1.5 mm. A primer (trade name: MEGUM3290, manufactured by Chemetall Inc.) was applied to the circumference surface of the elastic body layer so as to have a thickness of 2 μm and was dried.

Separately, the materials shown in Table 5 were dissolved in 186 g of an organic solvent, methyl ethyl ketone, to prepare a surface layer-forming solution.

TABLE 5

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Ionic liquid No. 3 in Table 1 | 0.97 g |
| (Product No.: EtPy.N441, manufactured by Mitsubishi Materials Electronic | |
| Chemicals Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

The surface layer-forming solution was spray-coated onto the circumference surface of the elastic body layer, on which the primer was applied and dried, so as to have a dried film thickness of 50 μm. Thus, a coating film of the solution was formed. Subsequently, the mandrel was heated in a nitrogen-purged oven (inert gas oven INL-60, manufactured by Koyo Thermo Systems Co., Ltd.) at 150° C. for one hour for usual crosslinking. While this mandrel was rotated at 300 rpm, the surface of the coating film was irradiated with an electron beam at an accelerating voltage of 110 kV and an irradiation current of 10 mA (electron beam irradiation apparatus: manufactured by Iwasaki Electric Co., Ltd., absorbed dose: 280 kGy) for 14 seconds under an atmosphere of an oxygen concentration of 10 ppm, followed by heating in an oven at 180° C. for 24 hours for secondary crosslinking. As a result, the coating film was cured to form a surface layer. Thus, a fixing roller according to this Example was produced. This fixing roller was evaluated by the method described above.

Separately, the surface layer-forming solution prepared above was spray-coated onto the outer circumference surface of an aluminum hollow cylindrical mandrel having an outer diameter of 80 mm so as to have a dried film thickness of 50 μm. Thus, a coating film of the solution was formed. Subsequently, the mandrel was heated in a nitrogen-purged oven (inert gas oven INL-60, manufactured by Koyo Thermo Systems Co., Ltd.) at 150° C. for one hour for usual crosslinking. While this mandrel was rotated at 300 rpm, the surface of the coating film was irradiated with an electron beam under the same conditions as above for secondary crosslinking to form a surface layer. This surface layer was used for measuring the “stress-strain curve” and the relationship between the electrical resistivity value (volume resistivity [Ω·cm]) and the strain of rubber of the surface layer according to this Example by the method described above.

The surface layer of the fixing roller according to this Example was analyzed by ¹³C solid NMR. The results show that a peak of a carbon atom derived from the structure represented by Chemical Formula (3) is present at the higher magnetic field side than the peak of a carbon atom derived from (CH₃)₂SiO. This proves that the silicone surfactant constituting the island phase has a crosslinked structure. Here, the analysis conditions of ¹³C NMR are as follows:

Apparatus: CMX-300, manufactured by Chemagnetics,

Temperature: 25° C.,

Reference material: HMB (external reference: 17.35 ppm),

Measurement nucleus: ¹³C nucleus,

Pulse width: 4.5 μsec (90° pulse),

Pulse repeating time: ACQTM 34.13 msec,

PD=5 sec (CP/MAS),

Data point: POINT 8192, SAMPO 1024,

Spectrum width: 30.03 kHz,

Pulse mode: CP/MAS,

Sample rotation rate: 4 kHz, and

Contact time: 1.5 msec.

### Example 2

The materials shown in Table 6 were dissolved in 186 g of methyl ethyl ketone to prepare a surface layer-forming solution.

TABLE 6

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Ionic liquid No. 2 in Table 1 | 0.57 g |
| (Product No.: EtPy.EF41, manufactured by Mitsubishi Materials Electronic | |
| Chemicals Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Example 2 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

### Example 3

The materials shown in Table 7 were dissolved in 186 g of methyl ethyl ketone to prepare a surface layer-forming solution.

TABLE 7

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Ionic liquid No. 1 in Table 1 | 0.36 g |
| (Product No.: EtPy.EF11, manufactured by Mitsubishi Materials Electronic | |
| Chemicals Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Example 3 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

### Example 4

The materials shown in Table 8 were dissolved in 186 g of methyl ethyl ketone to prepare a surface layer-forming solution.

TABLE 8

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Ionic liquid No. 6 in Table 1 | 0.99 g |
| (Product No.: EtMePy.N441, manufactured by Mitsubishi Materials | |
| Electronic Chemicals Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Example 4 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

### Example 5

The materials shown in Table 9 were dissolved in 186 g of methyl ethyl ketone to prepare a surface layer-forming solution.

TABLE 9

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Ionic liquid No. 5 in Table 1 | 0.59 g |
| (Product No.: EtMePy.EF41, manufactured by Mitsubishi Materials | |
| Electronic Chemicals Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Example 5 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

### Example 6

The materials shown in Table 10 were dissolved in 186 g of methyl ethyl ketone to prepare a surface layer-forming solution.

TABLE 10

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Ionic liquid No. 4 in Table 1 | |
| (Product No.: EtMePy.EF11, manufactured by Mitsubishi Materials | 0.38 g |
| Electronic Chemicals Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Example 6 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

### Comparative Example 1

The materials shown in Table 11 were dissolved in 186 g of methyl ethyl ketone to prepare a surface layer-forming solution.

TABLE 11

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Comparative Example 1 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

### Comparative Example 2

The surface layer-forming solution of Comparative Example 1 was spray-coated onto the circumference surface of the elastic body layer, on which the primer was applied and dried, so as to have a dried film thickness of 50 μm. Thus, a coating film of the solution was formed. Subsequently, the mandrel was heated in a nitrogen-purged oven (inert gas oven INL-60, manufactured by Koyo Thermo Systems Co., Ltd.) at 150° C. for one hour for usual crosslinking, and then heated in an oven at 180° C. for 24 hours for secondary crosslinking. As a result, the coating film was cured to form a surface layer. Thus, a fixing roller according to this Comparative Example was produced.

Separately, the surface layer-forming solution prepared above was spray-coated onto the outer circumference surface of an aluminum hollow cylindrical mandrel having an outer diameter of 80 mm so as to have a dried film thickness of 50 μm. Thus, a coating film of the solution was formed. Subsequently, the mandrel was heated in a nitrogen-purged oven (inert gas oven INL-60, manufactured by Koyo Thermo Systems Co., Ltd.) at 150° C. for one hour for usual crosslinking, followed by secondary crosslinking to form a surface layer.

A fixing member was produced as in Example 1 excluding crosslinking conditions, and was evaluated as in Example 1. In addition, the stress-strain curve and the relationship between the electrical resistivity value (volume resistivity [Ω·cm]) and the strain of rubber of the surface layer were measured as in Example 1.

### Comparative Example 3

The materials shown in Table 12 were dissolved in 186 g of methyl ethyl ketone to prepare a surface layer-forming solution.

TABLE 12

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Lithium salt having four fluorocarbons (lithium nonafluoro-1-butanesulfonate, | 0.44 g |
| manufactured by Tokyo Chemical Industry Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Comparative Example 3 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

### Comparative Example 4

The materials shown in Table 13 were dissolved in 186 g of methyl ethyl ketone to prepare a surface layer-forming solution.

TABLE 13

| | |
|---|---|
| Fluoropolymer including a terpolymer composed of vinylidene fluoride | 14 g |
| having iodine in a molecule as a reaction site, tetrafluoroethylene, and | |
| perfluoro (methyl vinyl ether) and including 66.5% by mass of fluorine | |
| (Trade name: LT252, manufactured by Daikin Industries, Ltd.) | |
| A copolymerizable silicone surfactant having a structure in which | 4.2 g |
| dimethylsiloxane and polyoxyalkylene are alternately and repeatedly | |
| combined with each other | |
| (Trade name: FZ2207, manufactured by Dow Corning Toray Silicone Co., | |
| Ltd.) | |
| Fluorine surfactant having a hydrophilic group and a lipophilic group and | 3.0 g |
| having a perfluoroalkyl group having 6 carbon atoms | |
| (Trade name: Megafac F-558, manufactured by DIC Corp., active ingredient: | |
| about 30%) | |
| Lithium salt having one fluorocarbon (lithium trifluoromethanesulfonate, | 0.22 g |
| manufactured by Tokyo Chemical Industry Co., Ltd.) | |
| Trially isocyanurate (Trade name: Taic, manufactured by Nippon Kasei | 0.9 g |
| Chemical Co., Ltd.) | |
| Benzoyl peroxide (water content: 25%, manufactured by Kishida Chemical | 0.9 g |
| Co., Ltd.) | |

A fixing member was produced as in Example 1 except that the surface layer-forming solution of Comparative Example 4 was used, and the fixing member was evaluated as in Example 1. In addition, the stress-strain curve and the relationship between the electrical resistivity value (volume resistivity [Ω·cm]) and the strain of rubber of the surface layer were measured as in Example 1.

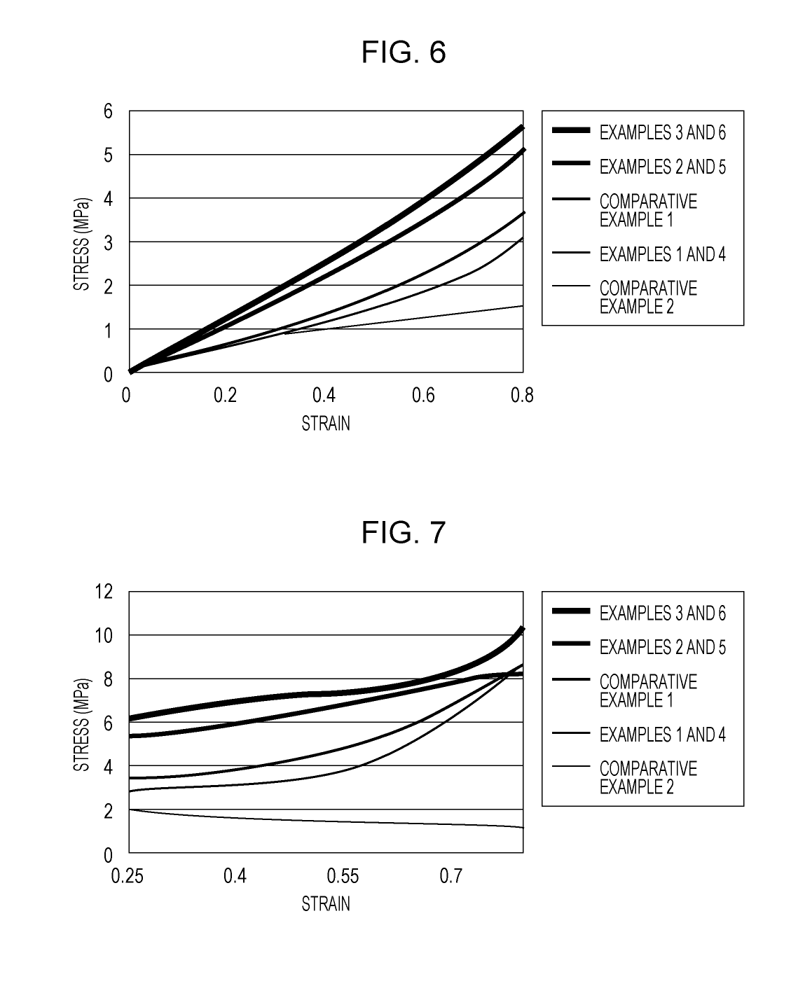

FIG. 6 shows stress-strain curves of Examples 1 to 6 and Comparative Examples 1 and 2. FIG. 7 is a graph showing tangential elastic modulus-strain curves of Examples 1 to 6 and Comparative Examples 1 and 2. In FIGS. 6 and 7, the Example numbers and Comparative Example numbers are shown in the order of strain from the highest to the lowest on the right side of each graph. The curves of Examples 3 and 6, the curves of Examples 2 and 5, and the curves of Examples 1 and 4 were approximately the same as each other, and though the curves of Comparative Examples 3 and 4 are not shown, they are most similar to the curves of Examples 2 and 5.

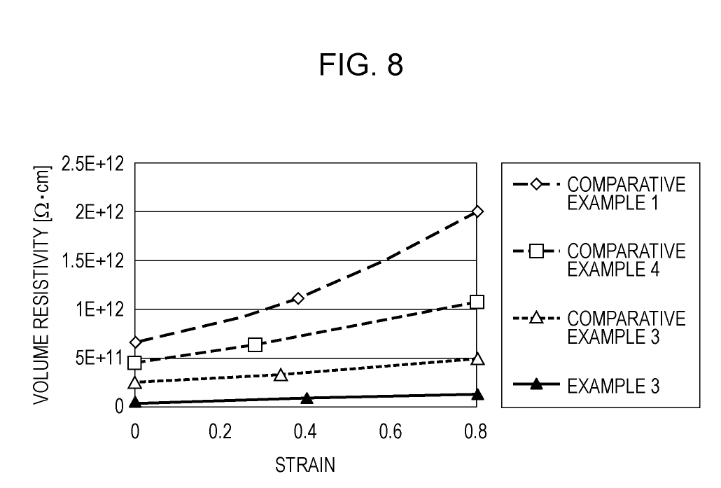

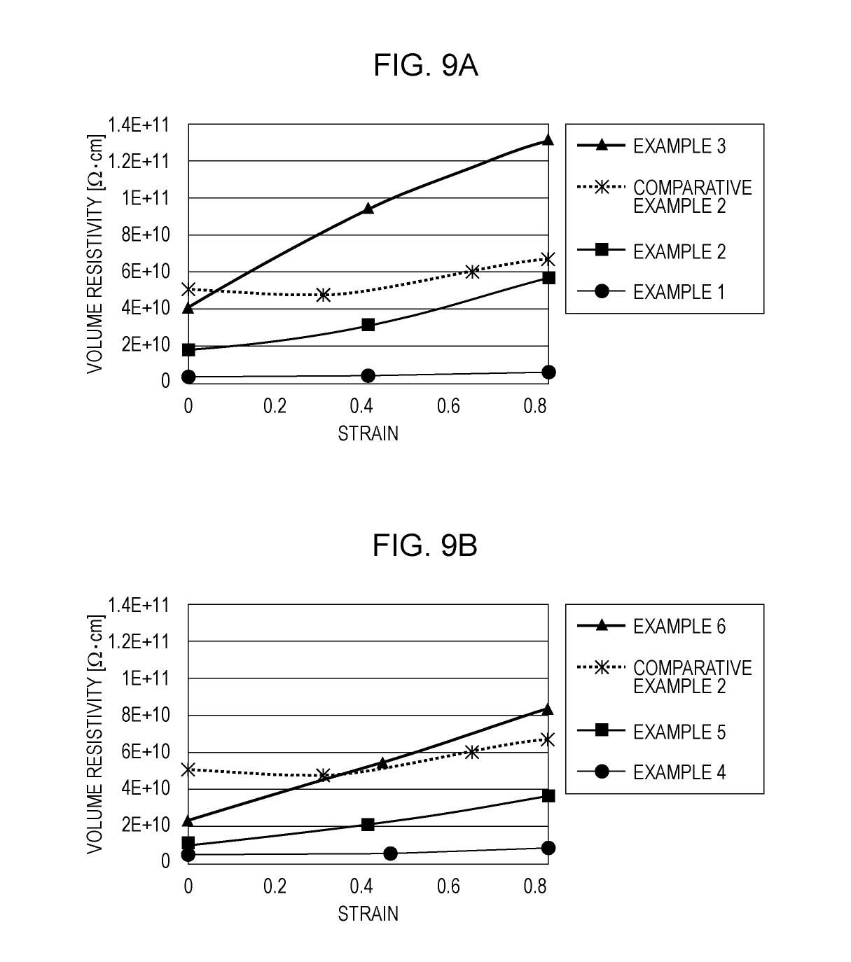

FIG. 8 shows relationships between the electrical resistivity value (volume resistivity [Ω·cm]) and the strain of surface layers according to Example 3 and Comparative Examples 1, 3, and 4. FIG. 9A shows relationships between the electrical resistivity value (volume resistivity [Ω·cm]) and the strain of surface layers according to Examples 1 to 3 and Comparative Example 2. FIG. 9B shows relationships between the electrical resistivity (volume resistivity [Ω·cm]) and the strain of surface layers according to Examples 4 to 6 and Comparative Example 2.

The evaluation results of the stress-strain curves and the relationships between the volume resistivity value and strain of rubber of Examples 1 to 6 and Comparative Examples 1 to 4 will now be described.

A comparison between the results in Comparative Examples 1 and 2 where the ion conducting agent is not added reveals that the surface layer in Comparative Example 1 where electron beam irradiation was performed has a volume resistivity value larger one order or more of magnitude than that in Comparative Example 2 where electron beam irradiation was not performed and that the surface layer in Comparative Example 1 is further increased by the strain of rubber. This suggests that a surface layer constituted so that a tangential elastic modulus, being the slope of a stress-strain curve of the surface layer, increases with an increase in strain in a strain range of 0.25 to 0.8 becomes to be easily charged by crosslinking through electron beam irradiation, compared to the surface layer not irradiated with an electron beam.

In contrast, in the surface layers containing ionic liquids of the present invention in Examples 1 to 6, the volume resistivity values decrease to the same level in Comparative Example 2 even if they are irradiated with an electron beam. This suggests that the surface layers containing ionic liquids are not easily charged even if the surface layer is crosslinked by electron beam irradiation.

The surface layers of Examples 1 to 3 including the same cationic species in the ionic liquids and the surface layers of Examples 4 to 6 including the same cationic species in the ionic liquids were respectively compared. The volume resistivity value decreases with an increase in the number of fluorocarbons of the anion in the ionic liquid and is hardly increased by the stain of rubber when the number of fluorocarbons of the anion is large. The stress-strain curves suggest that the rubber where the ionic liquid contains an anion having a small number of fluorocarbons highly crosslinks by electron beam irradiation. This probably causes the results that the volume resistivity value of the surface layer including an anion having a small number of fluorocarbons tends to be larger than that of the surface layer including an anion having a larger number of fluorocarbons.

In contrast, in Comparative Examples 3 and 4 where the surface layers contain an alkali metal salt, i.e., a lithium salt, the volume resistivity values are higher than those in Examples where the surface layers contain ionic liquids, and the volume resistivity values tend to be increased by the strain of rubber. This suggests that the surface layers containing lithium salts are readily charged, compared with the surface layers containing ionic liquids of the present invention in Examples.

The evaluation results of the fixing members of Examples 1 to 6 and Comparative Examples 1 to 4 will now be described. Table 14 shows the evaluation results for contamination by adhesion of the filler of paper and other substances. Table 14 shows glossiness of images after fixing, area rates of glossy portions in images after fixing, and the levels of strain of the surface layers of fixing rollers in fixing units (high-strain portions in contact with the convex portions of a paper surface and low-strain portions in contact with the concave portions of a paper surface).

In Table 14, difficulty in contamination of a surface layer is the degree of contamination of the cleaning web of a fixing apparatus equipped with the fixing member according to Example 1, and the evaluation criteria are as follows:

A1: no adhesion of contamination comes from paper dust and the filler of paper to the cleaning web is recognized,

A2: adhesion of contamination comes from paper dust and the filler of paper to the cleaning web is recognized to be higher than A1;

A3: adhesion of contamination to the cleaning web is higher than A2; and

A4: adhesion of contamination to the cleaning web is obviously higher than A3.

TABLE 14

| | | Image quality | | | |
|---|---|---|---|---|---|
| | | | Area rate of portion | | |
| | Degree of | | where toner does not | | |
| | contamination | | maintain particle shape | Strain of surface layer | |
| | of cleaning | Glossiness | to the whole area of | High-strain | Low-strain |
| | web | (°) | observation field (%) | portion | portion |
| Example 1 | A1 | 9.6 | 84 | 0.3-0.5 | 0.05-0.25 |
| Example 2 | A1 | 10.0 | 81 | Same as | Same as |
| | | | | above | above |
| Example 3 | A1 | 10.2 | 80 | Same as | Same as |
| | | | | above | above |
| Example 4 | A1 | 9.5 | 85 | Same as | Same as |
| | | | | above | above |
| Example 5 | A1 | 9.9 | 82 | Same as | Same as |
| | | | | above | above |
| Example 6 | A2 | 10.1 | 81 | Same as | Same as |
| | | | | above | above |
| Comparative | A4 | 9.7 | 83 | Same as | Same as |
| Example 1 | | | | above | above |
| Comparative | A1 | 6.0 | 90 | Same as | Same as |
| Example 2 | | | | above | above |
| Comparative | A3 | 10.0 | 82 | Same as | Same as |
| Example 3 | | | | above | above |
| Comparative | A3 | 9.9 | 81 | Same as | Same as |
| Example 4 | | | | above | above |

In the fixing members according to Examples 1 to 6 and Comparative Examples 1 to 4, the strain of the surface layer due to the irregularities of a paper surface corresponds to 0.05 to 0.25 in the portions where the strain is low and corresponds to 0.3 to 0.5 in the portions where the strain is high. This is based on the calculation results of contact structure analysis when a fixing member is pressed at a pressure of 0.3 MPa against the irregularities of a paper surface modeled with synthetic waves.

The surfaces of the surface layers of Examples 1 to 6 are probably hardly charged and are thereby prevented from adhesion of paper dust and other substances. In the cyan toner fixed images according to Examples 1 to 6, the degrees of glossiness are all 9° or more, the toner contact rates for evaluating conformity to the concave portions of paper are all 80% or more, and the image quality after fixing is good as a whole.

In contrast, in Comparative Example 1, though the image quality after fixing is well, the surface of the surface layer is probably readily charged to cause adhesion of paper dust and other substances.

In Comparative Example 2, the surface of the surface layer is hardly charged and is thereby prevented from adhesion of paper dust. However, the glossiness of the image after fixing is low. In Comparative Examples 3 and 4, though the image quality after fixing is good, the surface of the surface layer probably tends to be slightly charged to cause slight adhesion of paper components.

As described above, the fixing member of the present invention is advantageous for obtaining glossy toner fixed images while maintaining an advantage of rubber surface layers, i.e., the conformity to concave portions of paper, and is prevented from adhesion of contamination and can contribute to stable formation of fixed images with high image quality.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-148373, filed Jul. 4, 2011, which is hereby incorporated by reference herein in its entirety.

### REFERENCE SIGNS LIST

1 surface layer according to the present invention
2 thermal conductive layer made of silicone rubber
3 substrate
4 fixing roller
5 pressure belt
6 halogen heater
7 entrance roller
8 separation roller
9 steering roller
10 pressure pad
11 thermistor
12 collecting roller
13 web roller
14 cleaning web

1. A fixing member comprising a surface layer having a surface including a sea phase containing fluororubber and an island phase formed of a silicone compound having a crosslinked structure, wherein
the surface layer is constituted so that a tangential elastic modulus, being the slope of a stress-strain curve of the surface layer, increases with an increase in strain in a strain range of 0.25 to 0.8; and
the surface layer comprises an ionic liquid.

2. The fixing member according to claim 1, wherein the ionic liquid is a salt that is present in a liquid state in a temperature range of 25 to 100° C.

3. The fixing member according to claim 1, wherein the ionic liquid is at least one selected from the group consisting of imidazolium salts, pyrrolidinium salts, pyridinium salts, ammonium salts, phosphonium salts, and sulfonium salts.

4. The fixing member according to claim 3, wherein the ionic liquid includes
a cation selected from imidazolium ions, pyrrolidinium ions, and pyridinium ions, and
an anion having a fluoroalkyl group.

5. The fixing member according to claim 1, wherein the ionic liquid includes:
an anion selected from the group consisting of CF₃SO₃⁻, CF₃(CF₂)₃SO₃⁻, and (CF₃(CF₂)₃SO₂)₂N⁻; and
a cation selected from the group consisting of compounds represented by the following chemical formulae (1) and (2):

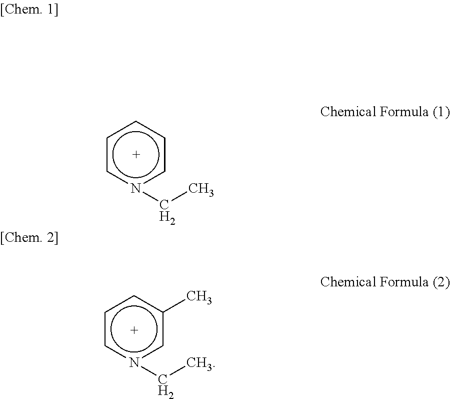

6. The fixing member according to claim 1, wherein the silicone compound having a crosslinked structure has a structure represented by the following Chemical Formula (3):

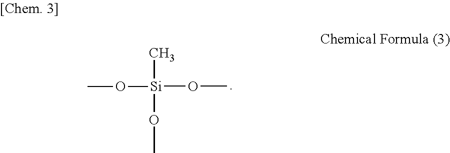

7. The fixing member according to claim 1, wherein the fluororubber is:
a bipolymer of vinylidene fluoride and hexafluoropropylene;
a terpolymer of vinylidene fluoride, hexafluoropropylene, and tetrafluoroethylene; or
a terpolymer of vinylidene fluoride having an ether group, tetrafluoroethylene, and perfluoro(alkyl vinyl ether).

8. The fixing member according to claim 1, wherein the surface layer is formed by hardening a coating film of a surface layer-forming solution containing a fluoropolymer, a silicone surfactant, and the ionic liquid by irradiating the coating film with an electron beam or by heating the coating film.

9. The fixing member according to claim 8, wherein the solution includes:
a fluoropolymer including a terpolymer of vinylidene fluoride having iodine or bromine in the molecule as a reaction site, tetrafluoroethylene, and perfluoro(methyl vinyl ether);
a silicone surfactant of a copolymerization type in which dimethylpolysiloxane and polyoxyalkylene are alternately and repeatedly linked to each other;
triallyl isocyanurate; and
the ionic liquid.

10. A fixing apparatus comprising the fixing member according to claim 1.

11. A fixing member comprising a surface layer having a surface including a sea phase containing fluororubber and an island phase formed of a silicone compound having a crosslinked structure, wherein
the surface layer is constituted so that a tangential elastic modulus, being the slope of a stress-strain curve of the surface layer, increases with an increase in strain in a strain range of 0.25 to 0.8;
the surface layer contains an ionic liquid;
the silicone compound having a crosslinked structure has a structure represented by the following Chemical Formula (3): 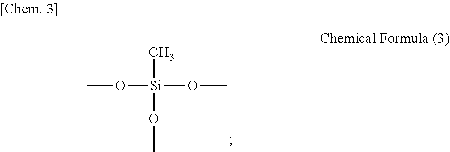
the fluororubber is a bipolymer of vinylidene fluoride and hexafluoropropylene; a terpolymer of vinylidene fluoride, hexafluoropropylene, and tetrafluoroethylene; or a terpolymer of vinylidene fluoride having an ether group, tetrafluoroethylene, and perfluoro(alkyl vinyl ether); and
the ionic liquid includes a cation selected from imidazolium ions, pyrrolidinium ions, and pyridinium ions and an anion having a fluoroalkyl group.

12. A fixing member comprising a surface layer having a surface including a sea phase containing fluororubber and an island phase formed of a silicone compound having a crosslinked structure, wherein
the surface layer is constituted so that a tangential elastic modulus, being the slope of a stress-strain curve of the surface layer, increases with an increase in strain in a strain range of 0.25 to 0.8;
the surface layer comprises an ionic liquid;
the silicone compound having a crosslinked structure has a structure represented by the following Chemical Formula (3): 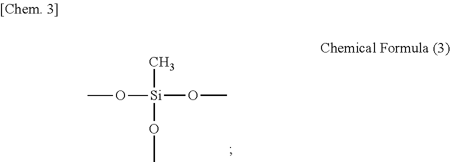
the fluororubber is a bipolymer of vinylidene fluoride and hexafluoropropylene; a terpolymer of vinylidene fluoride, hexafluoropropylene, and tetrafluoroethylene; or a terpolymer of vinylidene fluoride having an ether group, tetrafluoroethylene, and perfluoro(alkyl vinyl ether); and
the ionic liquid includes
an anion selected from the group consisting of CF₃SO₃⁻, CF₃(CF₂)₃SO₃⁻,
and (CF₃(CF₂)₃SO₂)₂N⁻, and
a cation selected from the group consisting of compounds represented by the following chemical formulae (1) and (2):

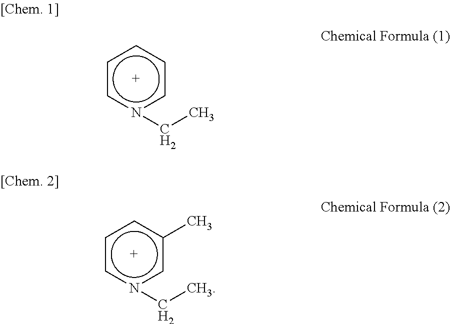

13. A method of producing a fixing member comprising a surface layer having a surface including a sea phase containing fluororubber and an island phase formed of a silicone compound having a crosslinked structure, wherein
the surface layer is constituted so that a tangential elastic modulus, being the slope of a stress-strain curve of the surface layer, increases with an increase in strain in a strain range of 0.25 to 0.8; and
the surface layer comprises an ionic liquid,
the method comprising:
forming a surface layer by hardening a coating film of a surface layer-forming solution containing a fluoropolymer, a silicone surfactant, and the ionic liquid by irradiating the coating film with an electron beam or by heating the coating film.

14. The method of producing a fixing member according to claim 13, wherein the solution includes
a fluoropolymer including a terpolymer of vinylidene fluoride having iodine or bromine in the molecule as a reaction site, tetrafluoroethylene, and perfluoro(methyl vinyl ether);
a silicone surfactant of a copolymerization type in which dimethylpolysiloxane and polyoxyalkylene are alternately and repeatedly linked to each other;
triallyl isocyanurate; and
the ionic liquid.
